(19) United States
(12) Patent Application Publication
(10) Pub. No.: US 2017/0015397 A1
(43) Pub. Date: Jan. 19, 2017

(54) Electric Propulsion System for Marine Applications and Method of Use

(71) Applicant: Cedar Marine Propulsion, Inc., Berkeley, CA (US)

(72) Inventors: Sean McGrath Mitchell, San Francisco, CA (US); William Stuart Price, II, San Francisco, CA (US)

(21) Appl. No.: 15/208,391

(22) Filed: Jul. 12, 2016

Related U.S. Application Data
(60) Provisional application No. 62/191,811, filed on Jul. 13, 2015.

(51) Int. Cl. B63H 21/17; B60L 7/10; B63H 21/38; H01M 2/10; H01M 2/20; H02J 7/00; H01M 10/625; H01M 10/6557; H01M 10/6568; H01M 10/42; H01M 2/12; H01M 10/46; B60P 3/10; H01M 10/613

(52) U.S. Cl. CPC B63H 21/17; B60P 3/1033; B60L 7/10; B63H 21/383; H01M 2/1077; H01M 2/206; H01M 10/613; H01M 10/625; H01M 10/6557; H01M 10/6568; H01M 10/425; H01M 2/1223; H01M 10/46; H02J 7/0013; B63B 2755/00; H01M 2010/4271; H01M 2010/4278; H01M 2220/20

(57) ABSTRACT

An electric propulsion system for use in marine applications. The system comprises rechargeable battery cells, AC or DC electric motors for propulsion, control units to manage the flow of energy between the battery cells and the motor, a water cooling loop that pumps water through heat exchangers then out of the watercraft for thermal management. Closed cooling loops may be employed to thermally manage the motor, batteries, controllers, inverters, charging apparatus and other components by running through coolant through the cooling loops to properly chill or heat the coolant fluid. The unit is charged through shore based power, solar and other sources, including the possibility of power sources through hull or hanging turbines to generate mechanical energy from the flow of water as the watercraft is propelled. The whole system is controlled by a vehicle control unit and a battery management system.

### CROSS REFERENCE TO RELATED APPLICATIONS

This application claims priority to provisional patent application Ser. No. 62/191,811 which is entitled Electric Boat Motor, filed Jul. 13, 2015, the entirety of which is incorporated herein by reference.

### TECHNICAL FIELD OF THE INVENTION

The present invention relates generally to propulsion systems for marine watercraft and more particularly to electric propulsion systems for marine watercraft. A trailer regenerative braking and boat/EV car recharging system also is provided. Finally, a method of providing power in an electric propulsion system in marine environments is provided.

### SUMMARY OF THE INVENTION

The present invention is directed to a modular battery pack for use in an electric propulsion system for a watercraft having a hull. The modular battery pack comprises a plurality of battery cells conformable into a shape configurable to the hull of the watercraft.

The present invention further is directed to an electric propulsion system for a watercraft having a hull. The electric propulsion system comprises a modular battery pack comprising a plurality of battery cells conformable into a shape configurable to the hull of the watercraft.

The present invention further is directed to a trailer for hauling a watercraft having a modular battery pack. The trailer comprises at least one axle and a plurality of wheels connected to the axle, a regenerative braking system comprising an electric motor in communication with the at least one axle; and an electric charging system whereby energy from the regenerative braking system is transferred to the modular battery pack of the watercraft.

Finally, the present invention is directed to a method of using an electric propulsion system for a watercraft in a marine application, the watercraft having a hull. The method comprises the steps of providing a plurality of battery cells in a shape configurable to the hull of the watercraft and providing power from the battery cells to an electric motor.

The foregoing and other objects, features, and advantages of the invention will appear more fully hereinafter from a consideration of the detailed description that follows.

### BRIEF DESCRIPTION OF THE DRAWINGS

FIG. 1A illustrates a cutaway plan view of a watercraft with an exemplary embodiment of an electric propulsion system of the present invention wherein the electric propulsion system is disposed with the hull of the watercraft.

FIG. 1B is a cross-sectional view of the watercraft of FIG. 1A taken along line 1B-1B.

FIG. 2A illustrates a cutaway plan view of a watercraft with an alternative exemplary embodiment of an electric propulsion system of the present invention wherein an electric motor is disposed exterior of the hull of the watercraft.

FIG. 2B is a cross-sectional view of the watercraft of FIG. 2A taken along line 2B-2B.

FIG. 3A illustrates a cutaway plan view of a watercraft carrying an alternative exemplary embodiment of an electric propulsion system of the present invention wherein an electric motor is disposed within the hull of the watercraft.

FIG. 3B is a cross-sectional view of the watercraft of FIG. 3A taken along line 3B-3B.

FIG. 4 is a plan view of a portion of a battery module comprising a battery pack of the electric propulsion system of the present invention.

FIG. 5A is a cross-sectional view taken along line 5A-5A of the module of FIG. 4.

FIG. 5B is an enlarged view of the substrate and battery cell configuration shown in FIG. 5A.

FIG. 6 shows a front or back elevational view of an exemplary battery module comprising a battery pack and an exemplary cooling loop of the electric propulsion system of the present invention.

FIG. 7A shows exemplary cooling loop connectors for a bi-direction cooling system to a battery module of the electric propulsion system of the present invention.

FIG. 7B shows an end view of a uni-directional embodiment of the cooling loop connectors to a battery module of the electric propulsion system of the present invention., wherein the cooling loop further comprises a plurality of tubes for carrying coolant.

FIG. 7C shows an end view of exemplary connectors for a bi-directional cooling system for a battery module of the electric propulsion system of the present invention.

FIG. 8 shows a top plan view of an exemplary battery module comprising a battery pack of the electric propulsion system of the present invention wherein the battery cells are positioned horizontally within the module.

FIG. 9 is a front or back elevational view of an exemplary V-shaped battery module of the electric propulsion system of the present invention.

FIG. 10 is a front or back elevational view of an exemplary V-shaped battery module of the electric propulsion system of the present invention and an exemplary cooling loop configured therein.

FIG. 11 is a side elevational view of an exemplary pentagon shaped battery module of the electric propulsion system of the present invention and the cooling loop configured therein.

FIG. 12 is a front or back side elevational view of an exemplary rectangular shaped battery module of the electric propulsion system of the present invention and the cooling loop configured therein.

FIG. 13 is a front or back elevational view of an exemplary V-shaped battery module of the electric propulsion system of the present invention, showing part of the collector plate, apertures and wire conductors, and a traced route for the cooling loop shown by a dotted line.

FIG. 14 is a schematic of a bi-directional cooling loop for the battery modules of the electric propulsion system of the present invention.

FIG. 15 shows a connector with a solenoid for the bi-directional cooling loop for the battery modules comprising the battery packs of the electric propulsion system of the present invention.

FIG. 16 is an exemplary schematic of the controls for multiple cooling loops for components of the electric propulsion system of the present invention.

FIG. 17A is an exploded view of an exemplary V-shaped module and/or battery pack of the present invention and shows a channel for housing electrical components, coolant and an exhaust port of the electric propulsion system of the present invention.

FIG. 17B is an enlarged end view of the channel of FIG. 17A.

FIG. 17C is perspective view of the cooling tubes used in the cooling system that optionally may run through the channel of FIG. 17A.

FIG. 18A is an exemplary schematic of the electrical components of the electric propulsion system of the present invention.

FIG. 18B is a schematic of an alternative embodiment of the electrical components of the electric propulsion system of the present invention.

FIG. 19A illustrates a cutaway plan view of a watercraft with an exemplary embodiment of an electric propulsion system of the present invention comprising an internal turbine regenerative charging system.

FIG. 19B is a cross-sectional view of the watercraft of FIG. 19A taken along line 19B-19B.

FIG. 19C is an enlarged view of an exemplary internal turbine regenerative charging system of the electric propulsion system of the present invention.

FIG. 20A illustrates a side view of a watercraft with an exemplary embodiment of the electric propulsion system of the present invention comprising an external turbine regenerative charging system having a pod suspended externally from the hull of the watercraft.

FIG. 20B illustrates a cutaway side view of an alternative embodiment of a watercraft with an exemplary embodiment of the electric propulsion system of the present invention comprising an external turbine regenerative charging system and an inverter, wherein the blades retract or fold.

FIG. 21 is an enlarged view of an exemplary external turbine regenerative charging system of the electric propulsion system of the present invention comprising a pod extending externally on the watercraft.

FIG. 22A shows an enlarged view of an alternative embodiment of an external turbine regenerative charging system of the electric propulsion system of the present invention wherein the propeller blades are engaged.

FIG. 22B shows an enlarged view of an alternative embodiment of an external turbine regenerative charging system of the electric propulsion system of the present invention wherein the propeller blades are retracted.

FIG. 23 is a schematic of an embodiment of an AC electric motor, inverter, and controller setup with two heat exchangers on a mount.

FIG. 24A is a side elevational view of a trailer regenerative braking and boat/EV car recharging system of the present invention.

FIG. 24B is an exploded view along the axle of the trailer regenerative braking boat/EV car recharging system of FIG. 24A.

### DETAILED DESCRIPTION OF THE INVENTION

Conventional combustion engines present a myriad of problems in marine applications, which can be alleviated by electric propulsion systems. Both internal and external combustion engines have size constraints and are complex, noisy, inefficient and unreliable. These engines have high costs of ownership and are an environmental catastrophe. Additionally, the harsh environment and conditions in which they operate often lead to breakdowns, which require costly repairs. Moreover, combustion engines lack the performance characteristics that make electric motors superior propulsion units in the marine environment.

In addition to the foregoing operational difficulties, ready supply of fuels is problematic in marine environments. Where fueling stations are capable of being located on the water, fuel costs significantly more due to logistical, supply and operating conditions. When fueling stations cannot be found on the water, boaters are forced to carry heavy tanks to and from their boats to fill up on shore. Even more problematic, marine fueling stations often suffer fuel spills directly into waterways, leading to serious environmental and pollution issues.

The electric propulsion system of the present invention solves all of these issues for marine applications. The present invention is modular and efficient, has significantly fewer moving parts, is substantially silent, environmentally friendly with an extremely small carbon footprint, while offering superior performance. These features in turn yield several advantages, including low maintenance, lower cost of ownership, more reliability and uncompromising performance. There is no need to travel miles to find the nearest potentially environmentally catastrophic fueling station to gas up or fill a marine vessel up five gallons at a time from a land based gas station. The present invention permits recharging by plugging into shore power at the dock, alleviating the difficulties associated with refueling combustion engines with fossil fuels. Quick charging technology allows boaters to recharge in very short time periods or overnight when the vessel is not in use.

A few conventional electric marine propulsion units address some of these issues; however, they are for low horsepower applications. Currently, very few companies are manufacturing electric propulsion systems for high horsepower needs in marine applications, and those systems fail to solve all of the problems presented herein. The electric propulsion system of the present invention solves all of these issues for marine applications.

Additionally, conventional electric marine propulsion units comprise a battery which sits atop the deck of the watercraft, occupying valuable space and creating a safety hazard. Some rectangular battery packs can sit in the hull but they occupy large amounts of space below decks. The battery pack comprising the electric propulsion unit of the present invention is configurable to an infinite variety of compact shapes to fit within small spaces within the hull of the watercraft, thus freeing valuable space for other uses and for freedom of movement of the passengers on the watercraft.

The present invention is applicable to all types of marine propulsion units, including inboard, outboard, sterndrives/inboard-outboard drive (I/O sterndrive), jet drive, and others. The present invention can be sold separately or as a power option when customers purchase a watercraft. The electric propulsion system of the present invention, comprising stern-drive, inboard and jet drive motors, are initially targeted to perform at least the equivalent level of 125 HP gas/diesel engines and higher; however, lower power levels also are possible. The electric outboards will target 15 to 750 HP or equivalent engines; however, larger and smaller HP equivalents can be offered, as well. The present invention further is applicable across all power ranges but is particularly adapted for use in the upper end of the power range for high performance watercraft, generally in the range of 125 HP to 750 HP.

The present invention is directed to an electric propulsion system for watercraft in marine applications. As used herein, “marine” and “marine applications” are used interchangeably to refer to activities and/or applications involving or relating to bodies or accumulations of water, whether fresh water or salt water, including, without limitation, oceans, seas, lakes, ponds, rivers, streams, springs, creeks, gulfs, sounds, harbors, coves, bays, channels, lagoons and the like. As will be explained in more detail herein, the electric propulsion system of the present invention comprises one or more rechargeable, modular battery packs, an electric motor, a cooling system, an inverter, if necessary for AC motors, a battery management system and a controller to control the performance of the motor. The electric propulsion system replaces internal combustion engines currently used in watercraft and fits into existing vessel hulls with very little modification. The electric propulsion system of the present invention can be charged from shore power outlets, during travel by turbines on or in the hull, by solar power and other sources of electricity.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

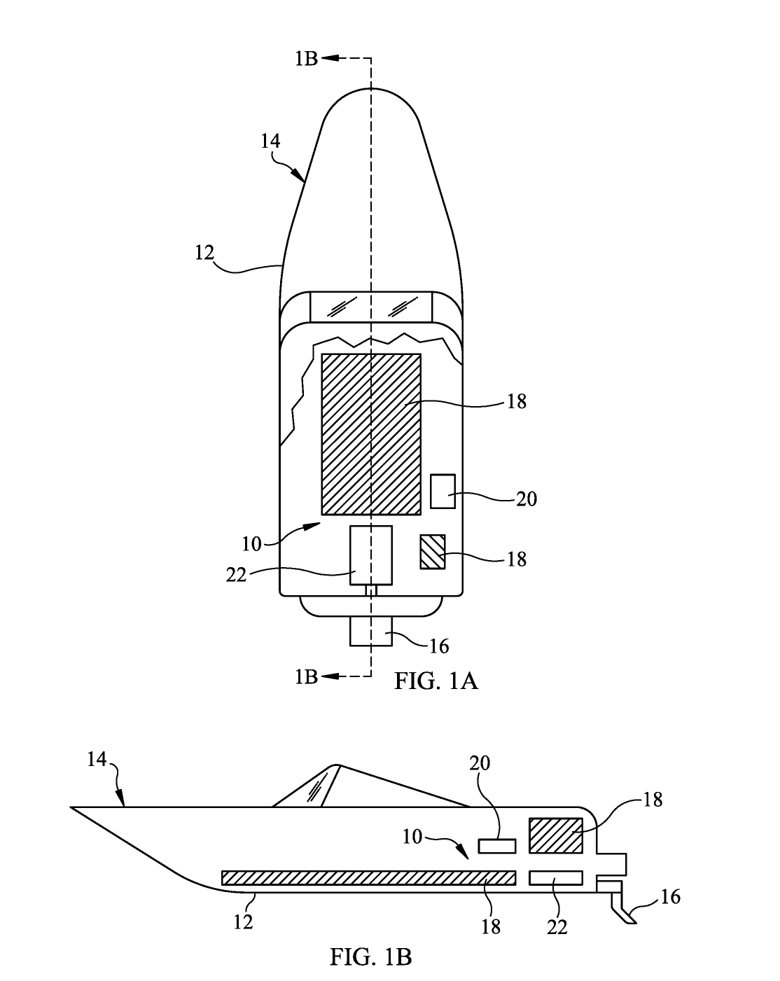

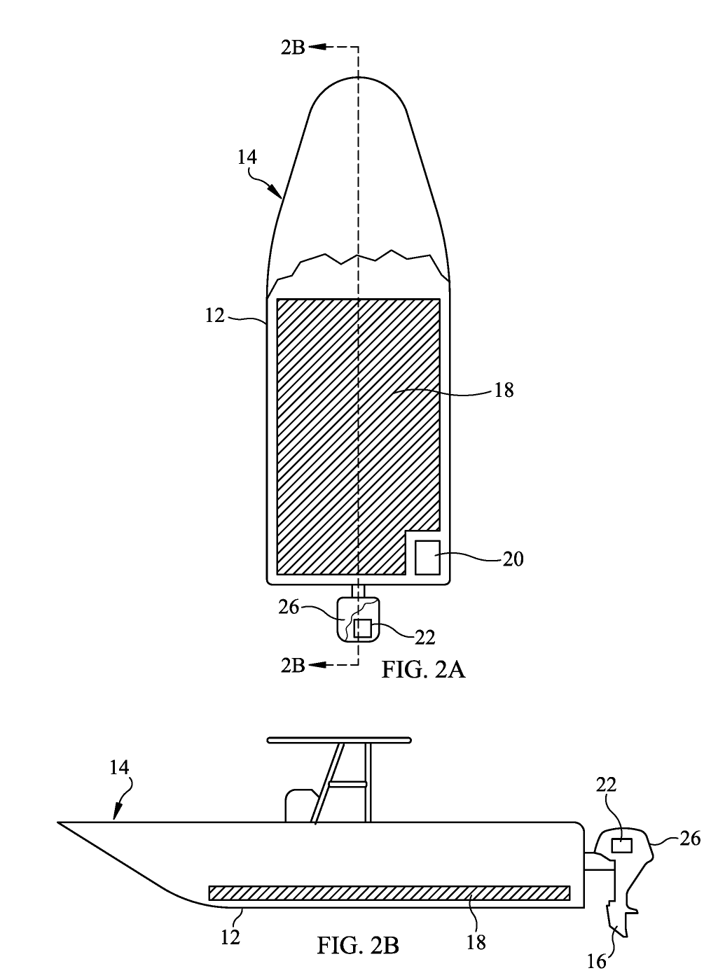

Turning now to the drawings in general, and to FIGS. 1A and 1B in particular, there is shown therein an embodiment of the electric propulsion system 10 of the present invention disposed in the hull 12 of a watercraft 14 or other vessel for use in marine applications. The system 10 may further comprise a thrust mechanism 16, such as a propeller or impeller. The electric propulsion system 10 comprises a plurality of battery cells 30 or a modular battery pack 18, a charger 20 and an electric motor 22. It will be appreciated that there may be more than one of each of the components comprising the electrical propulsion system 10 of the present invention. It further will be appreciated that the electric motor 22 may be comprised of outboard, inboard, I/O sterndrives, water jet, v-drive or other propulsion techniques. The motor 22 includes the actual power-train, which drives the thrust mechanism 16, battery packs 18, chargers, AC/DC converters, controllers and all other components yet to be described and which are necessary or useful to use electricity to charge the battery cells, which provide power to the system 10. It will be appreciated that system 10 components may comprise an integral unit but do not have to be one integral unit and may be positioned throughout the watercraft 14.

The electric propulsion system 10 is positionable within or on the hull 12 in a variety of configurations. The exemplary embodiment illustrated in FIGS. 1A and 1B depicts the motor 22 comprising an I/O sterndrive vessel or jet drive vessel with the battery pack 18 disposed within the hull 12. In another embodiment, the electric motor 22 and other components can be stored within the sterndrive unit outside of the hull 12. The battery pack 18 may be dispersed throughout the hull 12 of the watercraft 14 in a manner yet to be described.

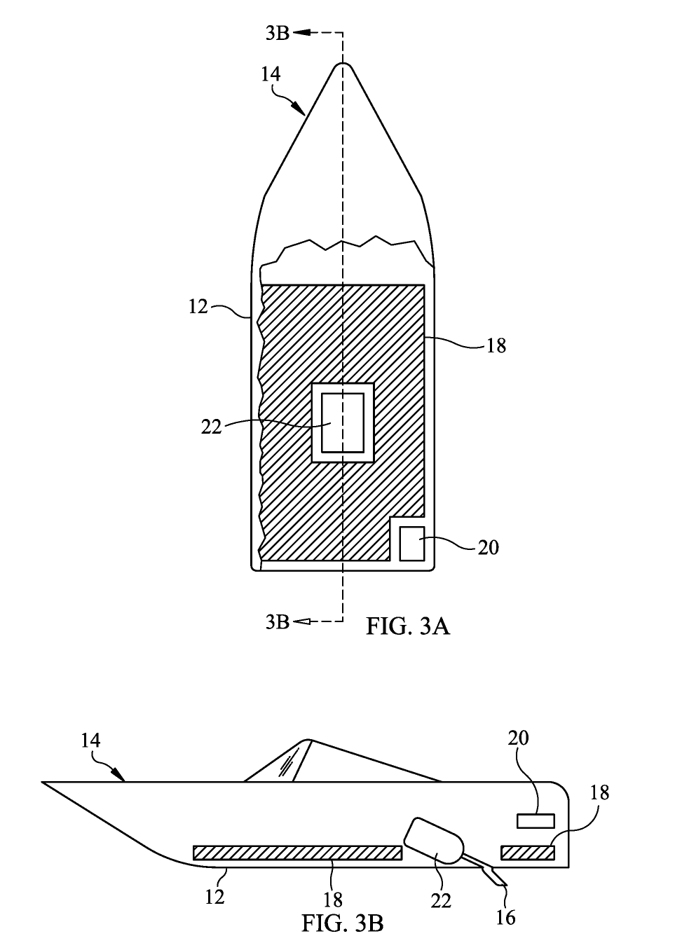

Turning to FIGS. 2A and 2B, an alternative embodiment of the electric propulsion system 10 is illustrated wherein the motor 22 is an outboard drive positionable in an outdoor housing 26 on the exterior of the hull 12 of the watercraft 14. In this embodiment, the motor 22, and other components which are yet to be described, may be stored in the outboard housing 26. It will be appreciated that, when the motor 22 is an outboard drive, these other components alternatively may be positioned in the hull 12 in connection with the battery pack 18.

In FIGS. 3A and 3B, yet another alternative embodiment of the electric propulsion system 10 is illustrated wherein the motor 22 comprises an inboard drive unit. In this embodiment, the motor 22, and other components not shown, may be generally centrally positioned within the hull 12. It will be appreciated that the components of the electric propulsion system 10 of the present invention may be configured in any way suitable to the requirements of the watercraft 14 and for the optimization of performance of the watercraft. The heretofore described embodiments are merely exemplary of possible configurations and are not intended to limit the possible configurations.

The modular battery pack 18 may comprise a single unit containing a plurality of battery cells or may comprise more than one battery packs positionable in multiple and variable locations throughout the watercraft 14, as shown, by way of example, in FIGS. 1B and 3B. In one exemplary embodiment of the electric propulsion system 10, the battery pack 18 is waterproof and disposed below decks in the hull 12 of the watercraft 14. Due to their modular design, the battery pack 18, whether a single pack or multiple packs, can be stacked above motor 22 or elsewhere throughout, in or on the watercraft 14. For example, the battery pack 18 may take the place of and conform to areas below deck where the fuel tank previously had been, or may occupy extra space in the engine compartment since the motor 22 of the electric propulsion system is significantly smaller than fuel engines, or fill other storage locations throughout the watercraft.

The electric propulsion system 10 of the present invention is easily integrated into existing hull types and watercraft with very limited modifications necessary. Accordingly, the electric propulsion system 10, including battery pack 18, electric motor 22 and other components may be sold to buyers as an alternative to combustion engines when purchasing a new watercraft or may be retrofitted post-purchase to an existing watercraft. Watercraft hulls generally have sufficient room to hold fuel tanks, combustion engines and storage under decks, allowing for plenty of room for the electric propulsion system of the present invention to be integrated therein. Weight distribution also is a key factor to keep in mind when adding and redistributing the weight of an electric engine in a boat hull. The battery pack 18 and drive train should be able to fit in the rear of the hull where current engines and gas tanks typically are stored, which should not drastically change how weight is distributed throughout the hulls. However, the modular design of the present invention allows for better weight distribution throughout the watercraft. In time, boat hulls will be able to be designed without the constraints of having a bulky combustion engine and fuel tank, allowing for better performance due to the ability to have better weight distribution with the modular batteries.

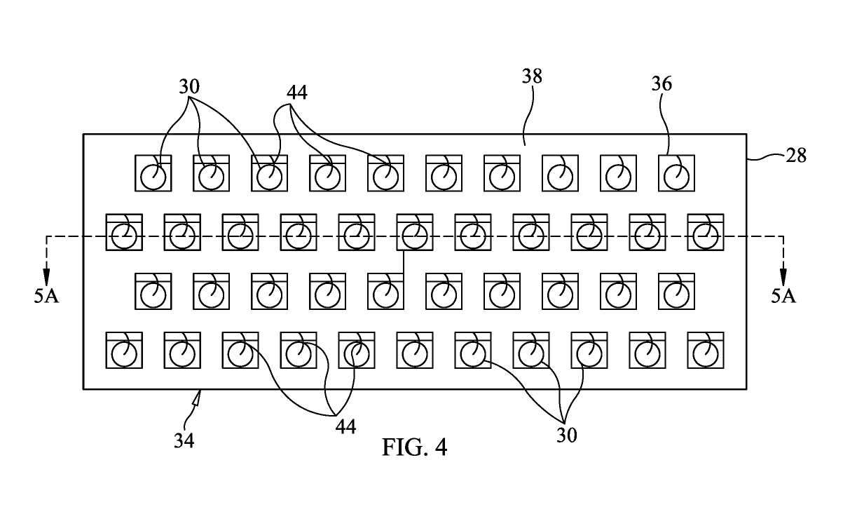

Turning now to FIG. 4, but with continuing reference to FIGS. 1A through 3B, the modular battery pack 18 comprises a plurality of battery cells 30 configurable into arrays of battery modules 34 formed from battery blocks. One or more battery cells 30 comprise a block. One or more blocks comprise a module 34. One or more modules 34 comprise a battery pack 18. The number of battery cells 30 in each block and module 34, and likewise the modules forming a battery pack 18, is a function of the size requirements of the watercraft 14 and power needs of the watercraft, among other factors. The number of battery cells 30 may range anywhere from about 10 battery cells to about 100,000 battery cells or more.

Any rechargeable battery may be used for the battery cell 30 in the practice of the invention, including without limitation nickel cadmium (NiCd) batteries, nickel-metal hydride (NiMH) batteries, lead acid batteries, lithium ion batteries, lithium polymer batteries, aluminum ion batteries, solid state batteries, lithium sulfur batteries, metal-air batteries, silicon-graphene composite batteries, graphene batteries, nanowire batteries, magnesium batteries, sodium ion batteries, and combinations thereof. In one embodiment of the invention, the battery pack 18 is comprised of a plurality of 18650 standard size, 18 mm by 65 mm lithium-ion rechargeable battery cells 30. Smaller battery cells 30 will allow the manufacturer to shape the battery pack 18 to (i) fit below decks of the watercraft 14, (ii) be stacked throughout the watercraft to optimize weight distribution, and (iii) fit into small spaces or a compartment initially designed to house a combustion engine and associated parts, such as fuel tanks, in retrofit applications. Rechargeable lithium-ion battery cells 30 enable design of a battery pack 18 that can be molded into currently available commercial boat hull designs without engendering significant structural changes in the hull.

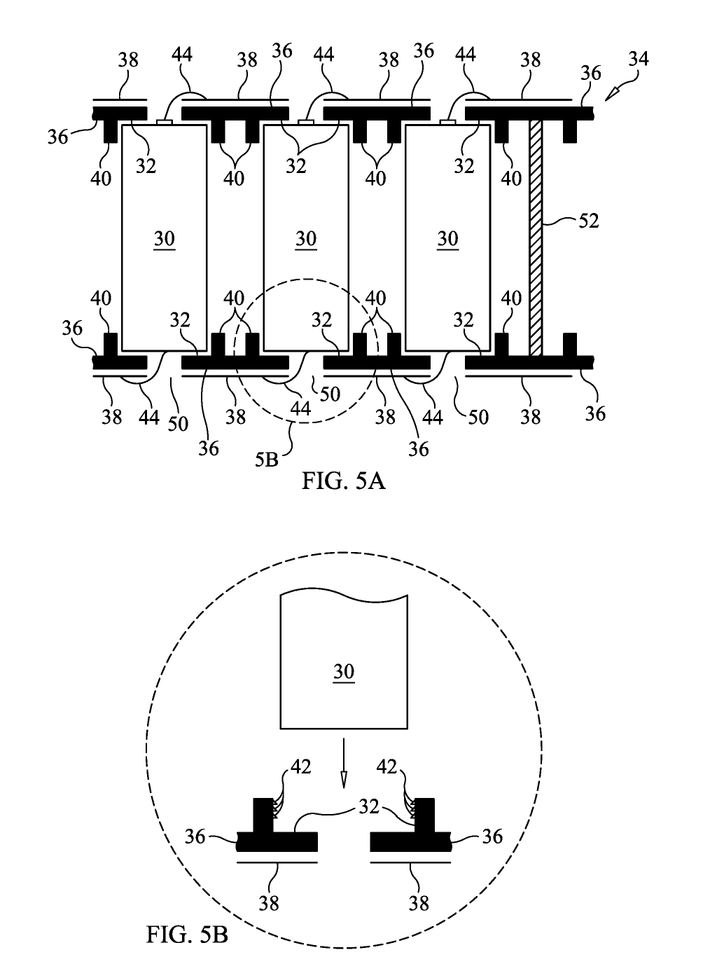

Turning now to FIG. 5A, but with continuing reference to FIG. 4, battery cells 30 comprising a battery module 34 may be configured into customizable arrays or modules, which form the battery pack 18 and are tailored to the needs of the watercraft 14. The module 34 may comprise a housing 28 for containing the battery cells 30. In another embodiment, substrates 36, yet to be described, serve as the housing. Battery cell receivers 32 within housing 28 are configured to receive the battery cells 30. FIG. 5A shows the battery cells 30 arrayed in rows with a plurality of non-conductive substrates 36 sandwiched between the battery cells and a plurality of collector plates 38 positioned near exterior faces of the substrates. Substrates 36 are used to hold the battery cells 30 firmly in place in battery cell receivers 32. Substrates 36 may vary in shape and size depending on how many battery cells 30 are being fitted into the battery module 34. One substrate 36 is placed on a front surface of the battery module 34 and another on a back surface of the module to secure the battery cells 30 in place.

In one embodiment, multiple front and back substrates 36 create battery blocks within each module 34. The substrates 36 may form grips 40 comprising each battery cell receiver 32. In one embodiment, the grips 40 are formed up a portion of the bottom and top of the substrate 36 to help hold battery cells 30 in place. The grips 40 may either be slightly smaller in diameter then the battery cells 30 and flex out when the battery cell is put in place in the battery cell receiver 32, thereby putting pressure on the battery cell 30 and keeping it in place. In another embodiment, the grips 40 may form prongs or teeth 42, shown in FIG. 5B, that protrude inwardly from the grips. When the battery cell 30 is pressed into the grip 40, the teeth 42 are pushed down flush with the side of the grip but still exert pressure against the battery cell 30 to help hold it in place in the battery cell receiver 32.

Wires and circuit boards may be tied into the substrates 36 to help carry information and control all of the battery cells 30, if needed. In another embodiment, the substrates 36 may be connected by supports 52 to help distribute weight across the module 34 and protect the battery cells 30 from being crushed.

Each substrate 36 forms an aperture 50 so that the battery cells 30 can be wired to the collector plates 38 in a manner yet to be described. The apertures 50 of the substrates 36 may be formed by drilling, milling, laser cutting or cutting by other available means.

In one embodiment, the substrates 36 on the front and the back of the battery pack 18 or on the front and back of module 34 can wrap around battery cells 30 situated at the outer perimeter of the pack 18 or module 34, thus fully enclosing the battery pack or module and offering additional structural integrity, support and protection to the battery pack or module. Additionally, the substrates 36 may be connected to the housing 28 by being glued, screwed or connected in another manner. In another embodiment, substrates 36 may be used to divide blocks of battery cells 30 within in each module 34.

Within each module 34 can be different blocks of battery cells 30 wired in parallel or series giving the modules and battery packs 18 that much more flexibility for the application. The battery cells 30 in each block or within modules 34 can face different directions, or polarities, depending on the need and connection style, whether series or parallel. Battery cells 30 can be wired in series or in parallel to form a block. Battery blocks can be wired in series or parallel to form a module 34. Modules 34 can be wired in series or parallel to form a battery pack 18. If a watercraft 14 has more than one battery pack 18, the packs 18 can be wired in series or parallel. The wiring depends on the needs of the watercraft 14 and the size of the battery pack 18. However, in one embodiment of the invention, battery cells 30 are wired in parallel to form a block; one or more blocks are wired in series to form a module 34; and modules are wired in series to form a pack 18. It will be appreciated that there may be any connector set up for the battery cells 30 within a block, and blocks within a module 34 and modules within a battery pack 18. The needs and requirements for the watercraft 34 in question and the requirements of the electric propulsion system 10 will dictate the construction of the battery module 34 and, ultimately, the battery pack 18.

With continuing reference to FIGS. 5A and 5B, the collector plates 38 situated near the substrates 36 are made out of conductive material, such as copper or other conductive material, and form apertures 50 that align between the battery cell receivers 32 formed by the substrates 36 and the placement of the battery cells 30, thus permitting connection of the battery cells 30 to the collector plates 38. The apertures 50 formed in the collector plates 38 and the substrates 36 may be formed by drilling, milling, laser cutting or cutting by other available means. The collector plates 38 may be connected to the substrates 36 or nonconductive walls of the housing 26 by adhesive or other securing means.

The battery cells 30 are connected to the collector plates 38 by electrical conductor wires 44 running through the apertures 50 formed in the substrates 36 and the collector plates. The electrical conductor wires 44 may made of thin conductive metal that can be connected by soldering, silver epoxy, welding or by other means to carry current back and forth between the battery cells 30 and collector plates 38. These electrical conductor wires 44 may be rated to disconnect or burn off if the battery cell 30 discharges more than its normal energy or current. This way, in case of damage or short circuit, the connection through each conductor wire 44 will break, removing the single battery cell 30 to which such conductor wire 44 is connected from the operation of system 10 and the protecting the rest of the battery module 34 and pack 18 from damage.

It will be appreciated that the battery cells 30 may be arrayed within the battery block, module 34, and modules 34 in the battery pack 18, in variable configurations. For example, battery cell receivers 32 can be configured to receive the battery cells 30 vertically rather than horizontally, which changes the general shape of each module 34. This variable modularity enables the battery pack 18 to conform to small and/or oddly shaped areas in the hull 12, such as where the fuel tank previously had been, or to occupy extra space in the engine compartment or fill other storage locations throughout the watercraft 14.

It now will be appreciated that the battery module 34 of the electric propulsion system 10 of the present invention is assembled by milling apertures 50 in the substrates 36 and collector plates 38 to achieve the desired battery cell 30 configuration. Apertures 50 are formed that will expose positive or negative terminals of each battery cell 30. Battery cells 30 are positioned in the battery cell receivers 32 in the substrate 36. Spacers may be used to position the battery cells 30 in place. The cooling loop 60, yet to be described, is positioned in the modules 34, comprising the battery pack 18. Heat conductive material may be inserted between the battery cells 30 and the cooling loop 60. After this, a top substrate 36 is inserted, along with fuses and contactors, if they are desired. Walls, such as support 52, may be added to the substrates 36 to reinforce the combination. Collector plates 38 and connector wires 44 are added and soldered to electrically connect battery cells 30 to the collector plates. Contactors are connected with HV terminals. Battery management system (BMS) wires, yet to be described, are run to the BMS board of the modules 34. The entire battery pack 18 is enclosed in waterproof, secure casing.

The battery pack 18 provides power to an electric motor (and power-train), being either alternating current (AC) or direct current (DC) 22, which will spin the thrust mechanism 16. In the case of an AC motor 22, an inverter 120 is needed to convert the DC to AC to spin the motor. The electric motor 22 is relatively small, ranging from about 4 inches to about 20 inches in diameter, and fit into the housing of an outboard engine. However, it can be smaller or larger depending on the needs of the watercraft 14.

Electricity pulled from the electric grid and the motor 22 rely on alternating current (AC) but the battery cells 30 use direct current (DC), a charger is used to convert the current. High speed chargers may be used to convert AC to DC from the electric grid to the battery cells 30, while an inverter 120 tied in with the power-train converts the DC from the battery cells 30 to AC for the induction motor 22, which then spins the thrust mechanism 16.

The electric motor 22 may be similar to those currently in use with the automobile industry. However, the electric motor 22 of the invention will be specifically designed for the marine industry to power inboard, outboard, stern-drive, jet-drive and other propulsion systems for commercial and recreational watercraft. Additionally, the electric motor 22 of the present invention will withstand the marine environment, both fresh water and saltwater, on all types of waterways, such as ponds, lakes, rivers, canals, bays, harbors and oceans, and offer a cleaner, substantially zero-emission propulsion source for watercraft.

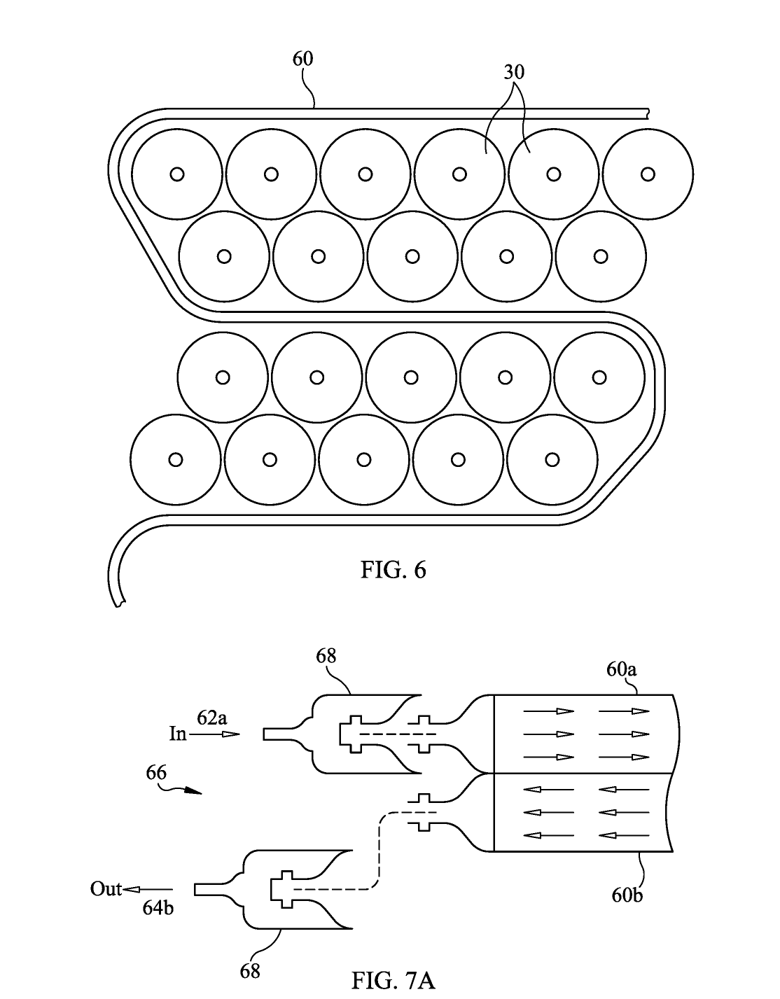

Turning now to FIG. 6, the battery cells 30 are cooled by water or other liquid coolant, such as anti-freeze or a combination of these two or other cooling liquid, transported through cooling loop 60, which travels through the battery modules 34 in the battery pack 18. The cooling loop 60 contacts each battery cell 30 within each module 34 to assist with thermal management of the battery pack 18. The coolant is pumped through the cooling loop 60 by one or more conventional pumps (not shown) situated in the hull 12 of the watercraft 14 or in an exterior housing 26. The coolant is cooled by one or more closed loop heat exchangers (not shown) with raw water, from the marine environment, running through the heat exchangers in a separate loop in a manner yet to be described. The battery cells 30 may be packed tightly or may contain spaces between them to allow for thermally conductive material to be applied inside to help with thermal management and spread heat equally between battery cells 30. In one embodiment of the invention as shown in FIG. 6, the battery cells 30 are configured in offset rows of two so that the cooling tube 60, which contacts each battery cell, can surround them. The coolant runs down one length of the battery cells 30, makes a U-turn then proceeds down the opposite side of the pairs of battery cells, and continues this winding pattern snaking motion until the coolant contacts each battery cell and exits the module 34. In one embodiment, each module's 34 cooling loop 60 communicates with and can flow on to the next module in the battery pack 18. As described in more detail herein, one embodiment of the cooling loop 60 will enable each module 34 to receive its own fresh coolant from the system 10 and send it back to the heat exchanger after it has traveled through the individual module 34.

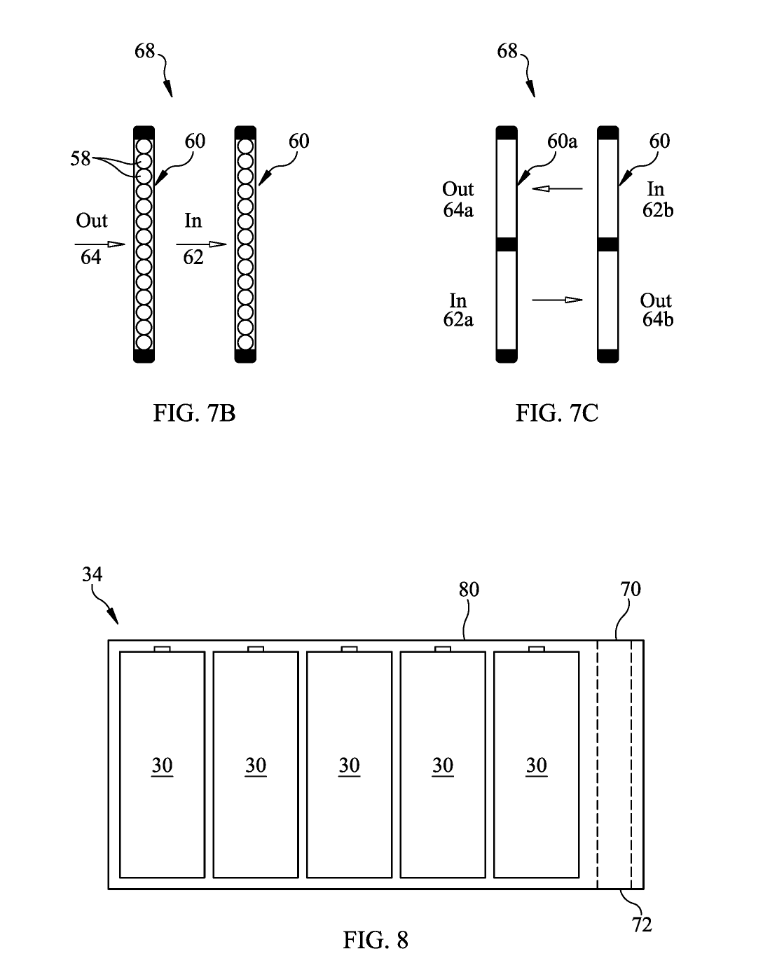

Turning to FIG. 7A, the cooling system 66 connectors 68 are shown. Connectors 68 attach the cooling loop 60 to the coolant supply. Connectors 68 may be any hose, tube or pipe. The cooling loop may comprise a plurality of smaller tubes 58 within the cooling loop 60, shown in FIG. 7B, or can be one single flow of liquid, as shown in FIG. 7C. The plurality of smaller tubes 58 situated within the cooling loop 60 are roughly the same size as the battery cells 30 (i.e., the same height as the battery cells, if battery cells are positioned vertically, and the same length front to back as the battery cells, if they are positioned horizontally). The tubes 58 of the cooling loop 60 may be wrapped in heat absorbing material that is nonconductive to help protect against short circuits. In one embodiment, a single coolant input 62 and a single coolant output 64 runs throughout the module 34.

In another embodiment, shown in FIGS. 7A and 7C, a bi-directional cooling system 66 is shown wherein there are four connections, two inputs and two outputs, for two cooling loops 60a and 60b, stacked and traveling in opposite directions. The first input 62a for cooling loop 60a carries coolant into the cooling system 66 and sends it through the module 34 or battery pack 18, while the first output 64a carries coolant out. The second input 62a receives the coolant pumped into cooling loop 60b, through which coolant flows in the opposite direction of the coolant in cooling loop 60a, and pumps the heated coolant out at output 64b. This helps keep all the battery cells 30 at similar temperatures and shares the heat equally throughout the module 34 or pack 18. Fresh coolant received in the inlet 62b of cooling loop 60b helps to cool battery cells 30 that are at the end of the cooling loop 60a. By the time this coolant reaches the end of its path through the module 34, the coolant has warmed in temperature; however, fresh coolant in the loop 60b above 60a and traveling in the opposite direction, provides additional cooling to the module. Additionally, heat will be exchanged between the coolant running in both directions in the respective cooling loops 60a and 60b. This bi-directional cooling system 66 embodiment also may have individual tubes 58 situated within the cooling loops 60a and 60b, as shown in FIG. 7B, or these cooling loops may just be filled with coolant. It will be appreciated that the battery module 34 may further comprise more than two bi-directional cooling loops 60a and 60b in each direction.

The entire cooling system 66 (comprising a pump, heat exchanger, cooling loops and coolant) is under pressure and is completely full with coolant while in use. Each module 34 comprising the battery pack 18 has at least one coolant input 62, or 62a and 62b in the case of bi-directional cooling loops 60a and 60b, and at least one coolant output 64, or 64a and 64b in the case of bi-directional cooling loops, that can be securely connected to the larger cooling system 66 with no leaks and can handle the pressure of the cooling system. A technician can easily disconnect the inlets 62, 62a and 62b and outlets 64, 64a and 64b so that the modules 34 can be removed from the battery pack 18. The coolant may be water, conventional anti-freeze, oil, a mixture or other type of liquid or liquid mixture.

Turning now to FIGS. 8, 9 and 10, exemplary modules 34 of battery pack 18 comprise substrates 36, collector plates 38, electrical wire conductors 44 and cooling loops 60, while conductive material and other module features have been omitted. These figures show the module 34 terminals 70 and 72, which allow the module to be connected to the overall electric propulsion system 10 or to other modules within a single battery pack 18. The terminals 70 and 72 run through the battery module 34 front to back. On the front of the battery module 34 are two terminals, one positive 70 and one negative 72. The terminals 70 and 72 run through the battery module 34 from the front thereof to the back, which also has two terminals, one positive 70 and 72 and one negative. This configuration permits multiple battery modules 34 to be connected in series or parallel and connected into the electric propulsion system 10. Depending on the wiring system, the battery module 34 may be flipped to match up the terminals 70 and 72, as needed. The terminals 70 and 72 may be screw in terminals, plug terminals or post terminals that have a nut which clamps down on a conductive material, or other type of terminal to connect the modules 34 comprising battery pack 18. The terminals 70 and 72 may be connected by flexible bus bars or other conductive materials, not shown. Outside walls or perimeter walls 80 of the modules 34 are made of nonconductive material and are used to enclose each battery module. Internal dividers of nonconductive material can also be used to separate battery blocks but allow room for cooling loops 60 to run therethrough. The substrates 36 may be connected to these outside walls 80, or the substrates themselves may form the outside walls of the module 34, as explained hereinabove. In one embodiment, the cooling loop 60 can be used as internal dividers between battery cells 30 and blocks of battery cells while also helping with thermal management and protecting against short-circuit and other damage.

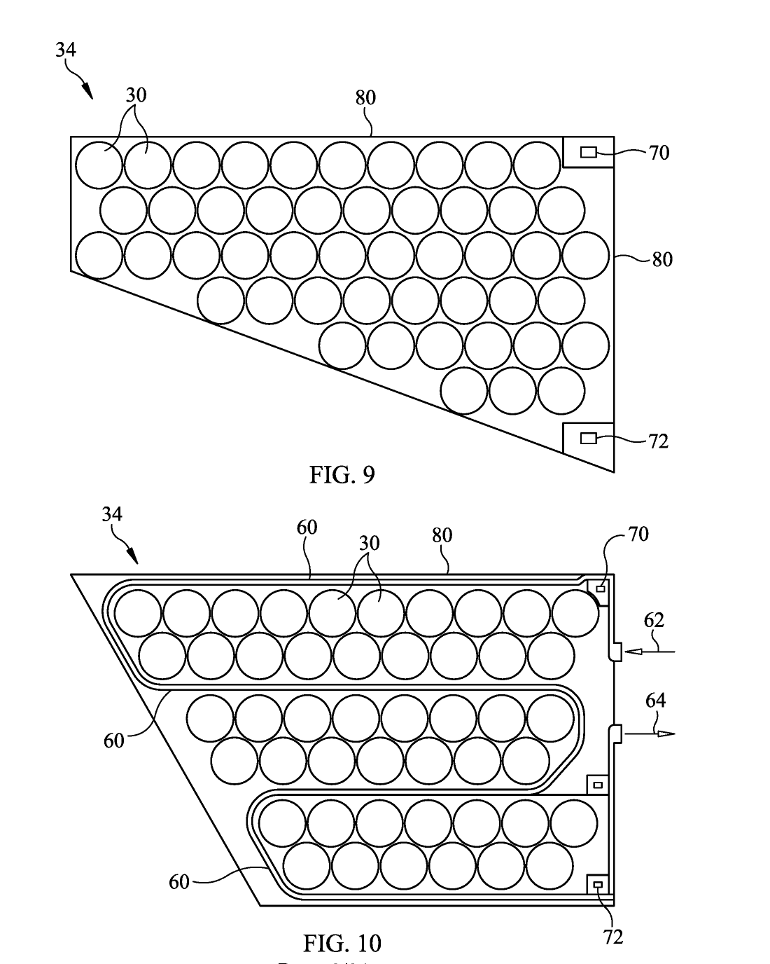

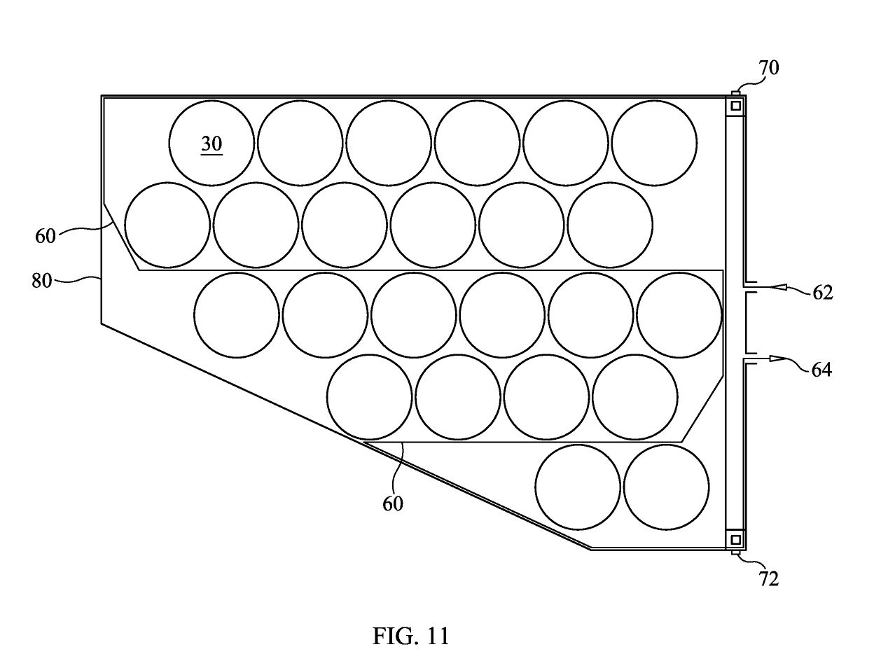

It now will be appreciated that the battery module 34, and the battery pack 18 formed by the modules, may take whatever shape is necessary for optimization of space, sizing and operational issues for the watercraft 14, including rectangular, spherical, trapezoidal, arcuate and polygonal shapes. In one embodiment of the invention, the battery module 34 and/or the battery pack 18 formed by the modules 34 takes the shape of a trapezoid to fill an awkward shape within the hull 12 of watercraft 14. In another embodiment, as shown in FIGS. 9 and 10, the battery pack 18 is configured to fill the space previously inhabited by a V-shaped fuel tank that conformed to the shape of the hull 12, thus optimizing available space. Owing to the shape of this embodiment, the cooling loop 60 may be more complex with coolant flowing in both directions or in a single direction.

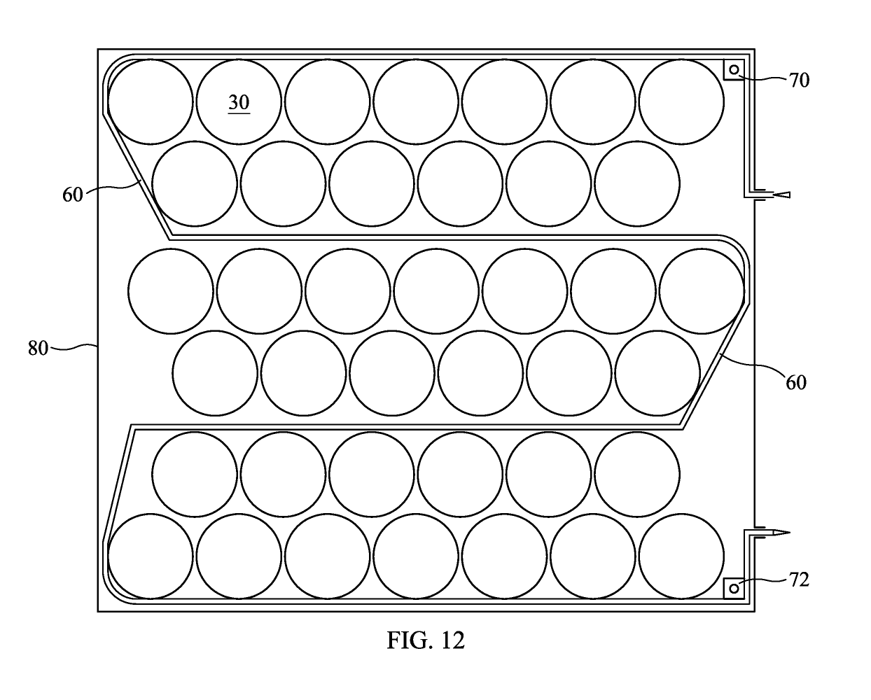

Alternatively, the battery module 34 may form a pentagon and further comprise a cooling loop 60, as shown in FIG. 11. This configuration optimizes the space formerly occupied by the fuel tank in the hull 12. FIG. 12 shows a rectangular battery module 34, as an alternative to a trapezoidal, pentagon or other shape for the battery pack 18.

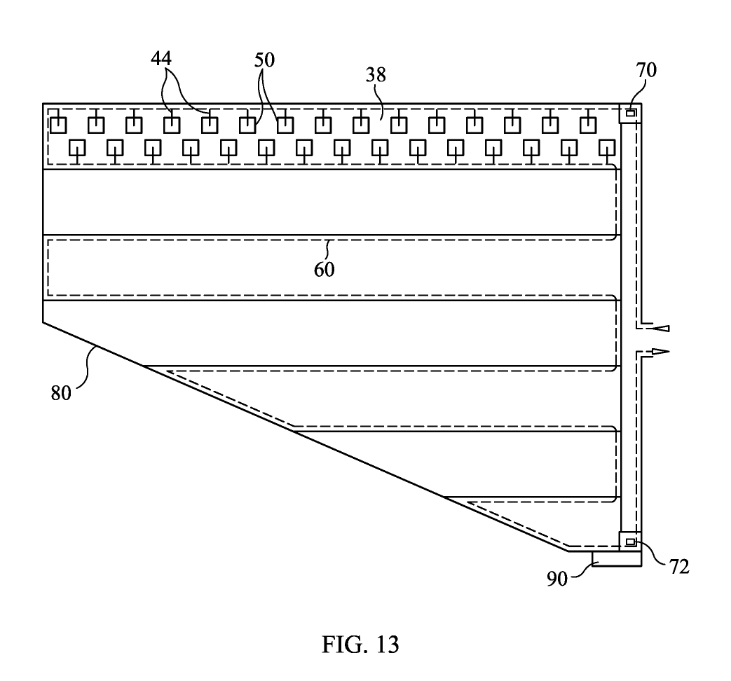

FIG. 13 shows the front or back view of V-shaped module 34 with part of the collector plate 38, with apertures 50 and electric conductors 44 therethrough, and a traced route for the cooling loop 60. In one embodiment, this module 34 may further comprise an emergency exhaust pressure valve 90. It will be appreciated that the emergency exhaust pressure valve 90 is adaptable for use with any shaped module 34 or battery pack 18. In the event of gas build up or a thermal occurrence, the pressure valve 90 would be triggered at a pre-determined pressure and release the gas or pressure into a secure section of a channel, yet to be discussed, and safely released from the watercraft 14. The pressure valve 90 is uni-directional and waterproof so that, in the event the pressure valve 90 is triggered, water cannot enter the battery module 34 or battery pack 18.

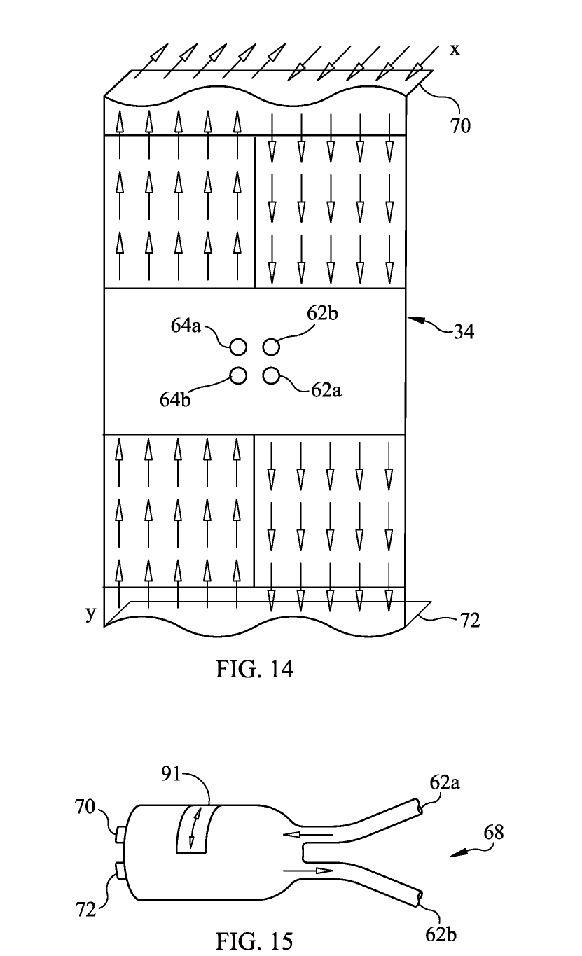

Turning now to FIGS. 14, a flow schematic for bi-directional cooling system 66 again is shown in three dimensions, with arrow x indicating coolant flow through cooling loop 60a and arrow y indicating coolant flow through cooling loop 60b. Turning to FIG. 15, the coolant connector 68 for inputs 62a and 64a and coolant outputs 62b and 64b, has a solenoid 91 tied into a Battery Management System (BMS), not shown in FIG. 15 and yet to be described, for each battery module 34 and a control unit, not shown in FIG. 15 and yet to be described, which may be used to restrict and permit coolant to flow to each module 34. The control unit can send more coolant to the battery module 18 if it is too warm or limit flow if it is too cool. In another embodiment, both the input and output connections, 62a and 62b respectively, would each have a solenoid 91 to make the cooling system 66 redundant.

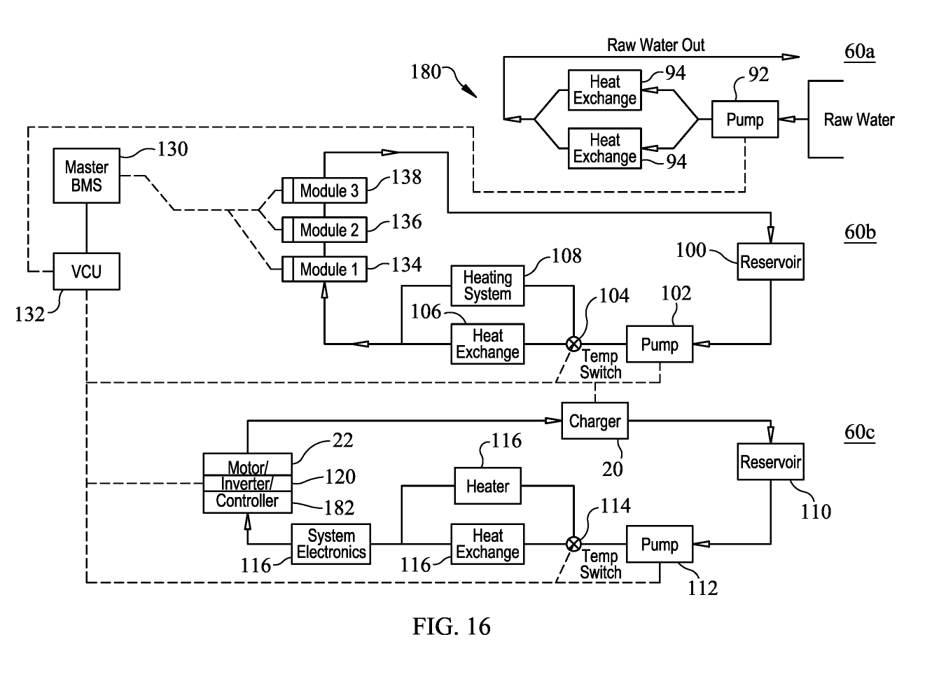

Turning now to FIG. 16, the BMS will be described. Each battery module 34 has a local BMS, 134, 136 and 138 that monitors the voltage of each battery block in the module, and the state of charge, battery cell protection, battery charger contact, cell balancing, current, fault detection, temperature, humidity, smoke, orientation, water and other variables and data. The number of module BMS 134, 136 and 138 shown in FIG. 16 is offered by example and is not intended to limit the number of module BMS in a battery module 34 or battery pack 18. These local BMS 134, 136 and 138 for the modules 34 communicate information to a master BMS 130 that works with a vehicle communication unit (“VCU”) 132. The master BMS 130 collects all of the information from the module BMS 134, 136 and 138 into one management system for the entire battery pack 18. During charging and discharging, the module BMS 134, 136 and 138 monitor the charge balance to safely discharge and recharge each battery block and battery module 34. By communicating with the master BMS 130 and VCU 132, individual blocks and modules 34 can be taken offline and can do a total system shutdown if water or other issues are sensed in or around the battery cells 30. Local module BMS 134, 136 and 138, along with the master BMS 130, monitor each battery pack's 18 heat and the heat of the coolant, which then control each BMS module solenoid 91 to control the flow of the coolant and rate at which the pumps work. The master BMS 130 system also interfaces with the VCU 132 to tell the user the expected range, battery voltage, usage, and other information. This information can be displayed on the dashboard of the watercraft 14, onboard computer screen, mobile application or other feature. The master BMS 130 and module BMS 134, 136 and 138 can also bleed voltage from battery cells 30 or blocks of battery cells to ensure that they do not overcharge.

Each battery pack 18 will have a master fuse (not shown) to protect the modules 34 comprising the pack against short circuits or other damage while also protecting the people on the watercraft 14. In another embodiment, fuses (not shown) can be added between modules 34 and set to trip if more current passes through it than is rated for the modules connected previously, thereby protecting the greater pack from damage in the event of a short circuit. These fuses will have a current carrying capacity just below the maximum that the wire connectors 44 can handle. In the case of a short circuit, the fuse will blow before the wire connections 44 do, thereby protecting the battery cells 30. In another embodiment, this type of fuse connection can be leveled down to operate between blocks in a module 34. Fuses can be set around electrical connections to protect various systems and equipment. Any number of fuses can be used throughout the electric propulsion system 10 to protect it.

In one embodiment, the entire watercraft 14 will have master contactors (not shown) to allow the battery pack 18 to be connected with the inverter 120, controller 170 and motor 22. In another embodiment, each module 34 comprising a battery pack 18 can have contactors between itself and the next module to further protect against arcing. Various numbers of contactors can be setup throughout the electrical systems of the watercraft 14 to protect the unit and passengers.

With continuing reference to FIG. 16, the flow diagram for an exemplary embodiment of the cooling loop control unit 180 for the cooling system 66 will be described. Cooling loop 60a carries raw water as the coolant, as hereinabove described. Raw water from the marine application in which the watercraft 14 is being operated, is pumped in through one or more pumps 92, either from an aperture in the motor 22 or another access point on the watercraft 14. The one or more pumps 92 send the water to one or more heat exchangers 94 before the water is expelled back into the marine environment through an exhaust port or other point. Cooling loop 60b is a closed loop system with a coolant reservoir 100, one or more pumps 102, a temperature switch 104 that can control a valve that sends the coolant through one or more heat exchangers 106 or a heating system 108, then to one or more battery packs 18 before returning to the reservoir 102 to continue the cycle. The heating system 108 can be omitted, if necessary or desirable. Cooling loop 60c is a closed loop system with a reservoir 110, one or more pumps 112 and a temperature switch 114 that can send the coolant to one or more heat exchangers 116 or a heating system 118 before going through system electronics 116, the inverter 120, motor 22, controller 182 and charger 20 before returning to the reservoir 110 to continue the cycle. More cooling loops 60 may be added to the electric propulsion system 10 if needed for other electronics or to separate loops 60 for the motor 22, inverter 120 or charger 124. The master BMS 130 communicates with each individual battery module BMS, 134, 136 and 138, that read temperature and other data and that may control the cooling loops 60a, 60b and 60c hookup solenoids. It also communicates with the system 10 VCU 130, which controls the pumps 92, 102 and 122, charger 20, motor 22, inverter 120, temperature switches 104 and 114 and other systems on the watercraft 14. A larger master solenoid (not shown) may be installed on the loops 60a, 60b and 60c to control the flows, or this may be carried out via the pumps 92, 102 and 112.

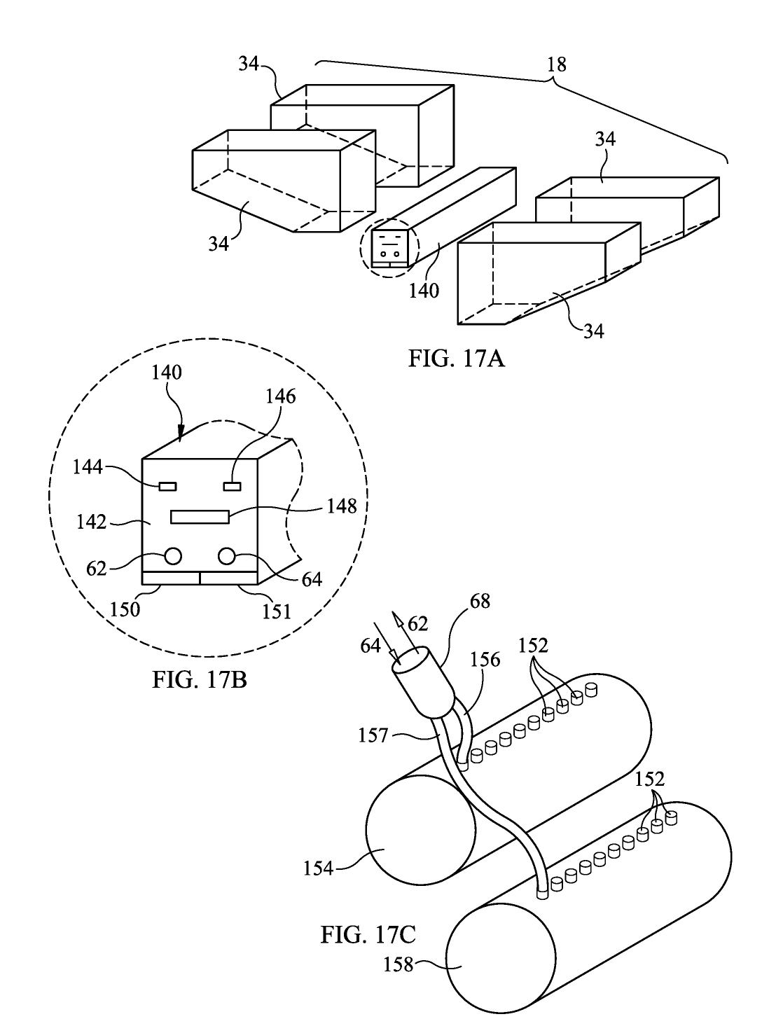

In V-shaped and other shaped battery packs 18, a channel 140, which is nonconductive and shown in FIG. 17A, helps hold each battery module 348 in battery pack 18 in place and also runs high voltage wires, bus bars, cooling loops, BMS wires and other components through the battery pack 18 to output ports. In each battery pack 18, modules 34 are wired to the adjacent module in front or behind it, and the channel 140 holds them in place and runs components through the battery pack 18. Multiple battery modules 34 may be positioned along both sides of the channel 140 of V-shaped battery pack 18 or other shaped battery pack.

Turning now to FIGS. 17B and 17C, below the channel 140 are emergency exhaust output conduits 150 and 151. Gas pressure build-up in a battery pack 18 triggers its corresponding pressure valve, which releases the gas, or other source of pressure, into the channel 140. From here, the pressurized gas is released through one or more valves in a back side (not shown) of the channel 140, which is vented out with exhaust of the watercraft 14 at the point where the raw water in cooling loop 60a is pumped out. In another embodiment, pressurized gas may be vented through an alternate point in the watercraft 14, which protects passengers and people near the watercraft.

In FIG. 17B, surface 142 of the channel 140 receives HV wires, buses, coolant, BMS wires and other components. The channel 140 has at least one HV negative connection 144, at least one positive HV connection 146, one or more coolant input hookups 62 and 64 and one or more wire pin connectors 148 for wire connections. All of these connections are industrial waterproof rated and hold strong against vibrations.

When the channel 140 is present, master cooling input and output tubes or pipes 154 and 158 run through the channel 140. As explained above, the cooling system 66 can have one or more cooling loop inputs 62 and one or more cooling loop outputs 64. After leaving the heat exchanger 94, 106 or 116 or heater 108 or 118, the coolant enters the master coolant input 154 with a manifold to send it to an individual battery pack 18. As shown in FIG. 17C, the master coolant inputs 154 or master coolant outputs 158 can have a plurality of nipples 152, the number depending on the need of the cooling system 66. Smaller input tubes 156 and output tubes 157 connect to these nipples 152 and lead to the connectors 68 that feed coolant to and take coolant away from the cooling line inputs 62 and cooling line outputs 64. Cooled coolant leaves master coolant input 154 through nipple 152 and enters tube 156 before proceeding through connector 68 to cooling line input 62. Once the coolant has traveled through the battery pack 18 or module 34, the coolant exits through the cooling line output 64 through connector 68 into the smaller output tube 157 and down through nipple 152, where the coolant enters the master coolant output 158, which returns the coolant to the reservoir 100 or 110, heat exchanger 94, 106 or 116 or heater 108 and 118. In another embodiment, a fan can be set up to augment the liquid cooled system and help circulate air around the modules in a pack to help cool them.

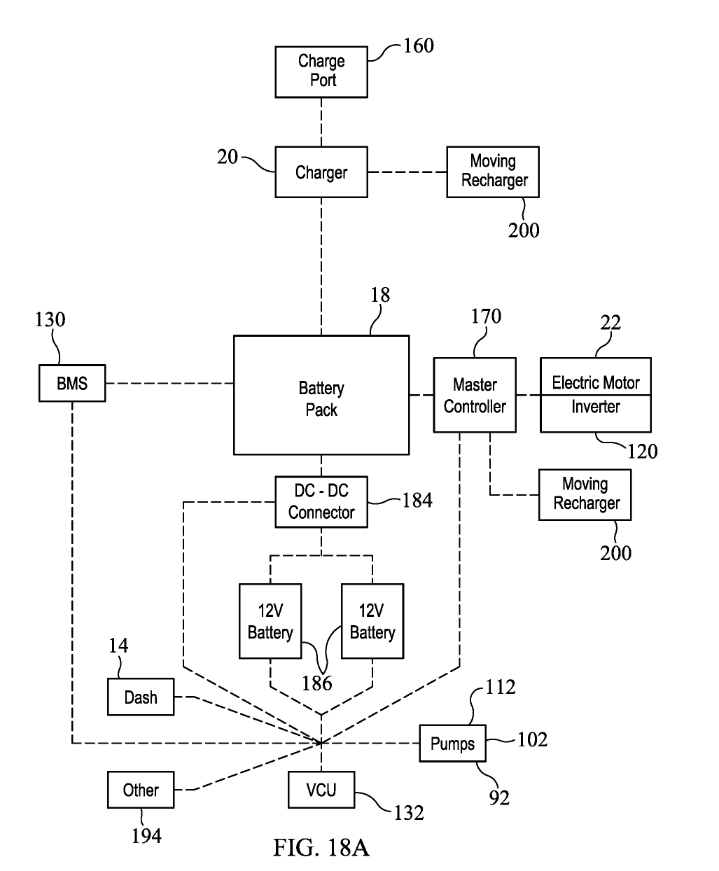

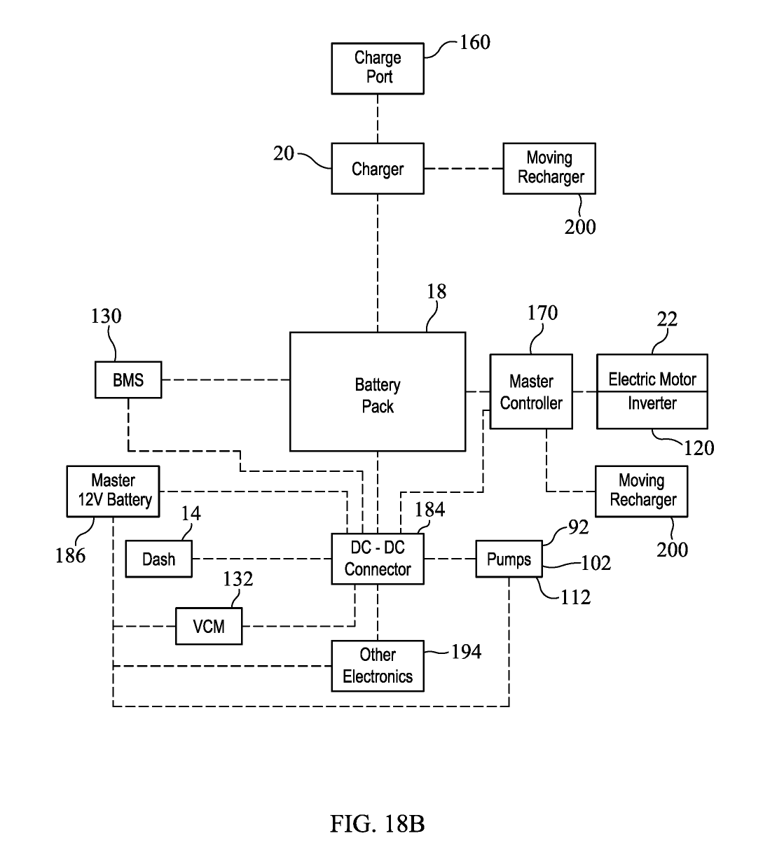

Turning now to FIG. 18A, an exemplary electrical schematic of the electrical system of the electric propulsion system 10 is shown. A charging port 160 receives power to charge the battery pack 18 through the charger 20 that converts AC power to DC power and sends it to the battery pack. In the case of an AC motor 22, the battery pack 18 sends DC power to the inverter 120, which converts the DC power to AC to spin the AC electric motor 22 via a controller 180. If a DC motor 22 is being used, then an inverter 120 is not needed. The battery pack 18 also sends power to a DC-DC converter 184, which drops the high voltage down so it is compatible with other systems requiring a lower voltage on the watercraft 14. The battery pack can recharge onboard vehicle batteries, (12V batteries, marine batteries, car batteries and others). It also allows power for the dashboard of the watercraft 14, VCU 132, pumps 92, 102, 112, master BMS 130, module BMS units 134, 136 and 138 and other system components 194. The master BMS 130 is also tied into the battery pack 18 so that it can monitor the module BMS 134, 136 and 138 of each individual battery module 34 and report it to the VCU 132.

In one embodiment, the watercraft 34 will have a moving recharger 200, such as an internal turbine that is spun by water during propulsion or when the watercraft is slowing down, in a manner yet to be described. This, in turn, generates power that can recharge the battery pack 18 during travel, much like regenerative braking in an electric car. In another embodiment, the turbine feeds into the inverter 120, which puts the energy back to the battery pack 18. In another embodiment, the turbine feeds the energy to the vehicle's charger, which then sends it to the battery pack 18. Additionally, in an alternative embodiment, the motor 22 can provide regenerative power to the battery pack 18 when the motor stops pushing the watercraft forward or backwards. The thrust mechanism 16, such as a propeller, is no longer moving the watercraft forward or reverse, and as the watercraft's inertia is still moving it would spin the propeller, which spins the motor 22 and regenerates power, which is fed back to the battery pack 18. Water flowing through the internal turbine and/or hanging propeller or thrust mechanism 16 would also create regenerative power. Although the motor 22, inverter 120 and controller 170 are shown together, they do not have to be one unit. In an alternative embodiment, the electrical schematic for which is shown in FIG. 18B, the battery pack 18 feeds the DC-DC converter 184, which then feeds lower voltage power to the watercraft's 14 other components, including other batteries 186 on the watercraft, which can then be used as a backup. This embodiment also comprises a turbine recharger 200 as well as a prop regenerative braking system, both of which are yet to be described. The motor 22, inverter 120 and controller 170 do not have to be one unit.

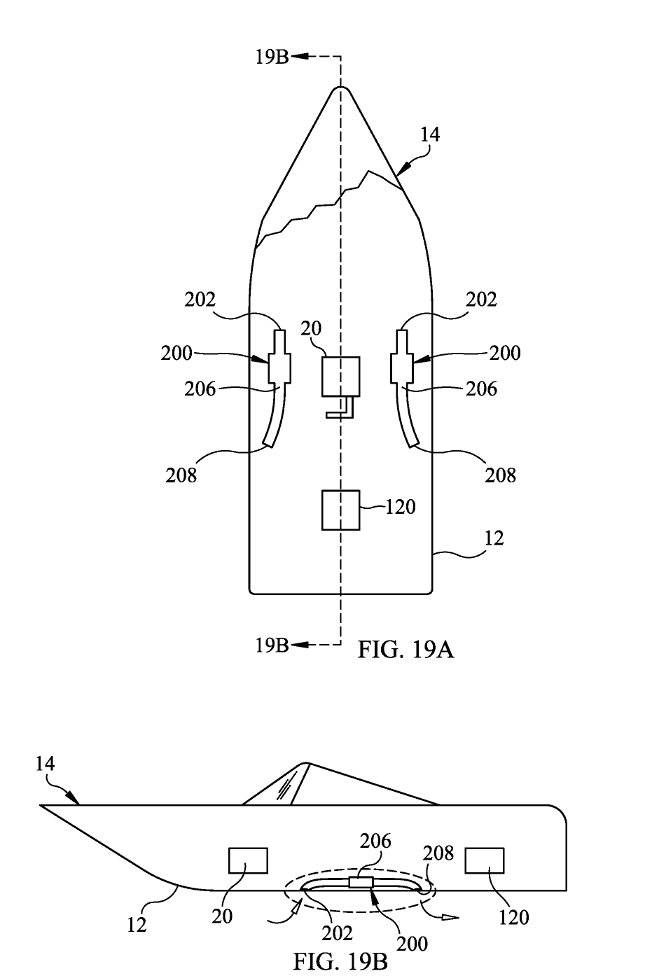

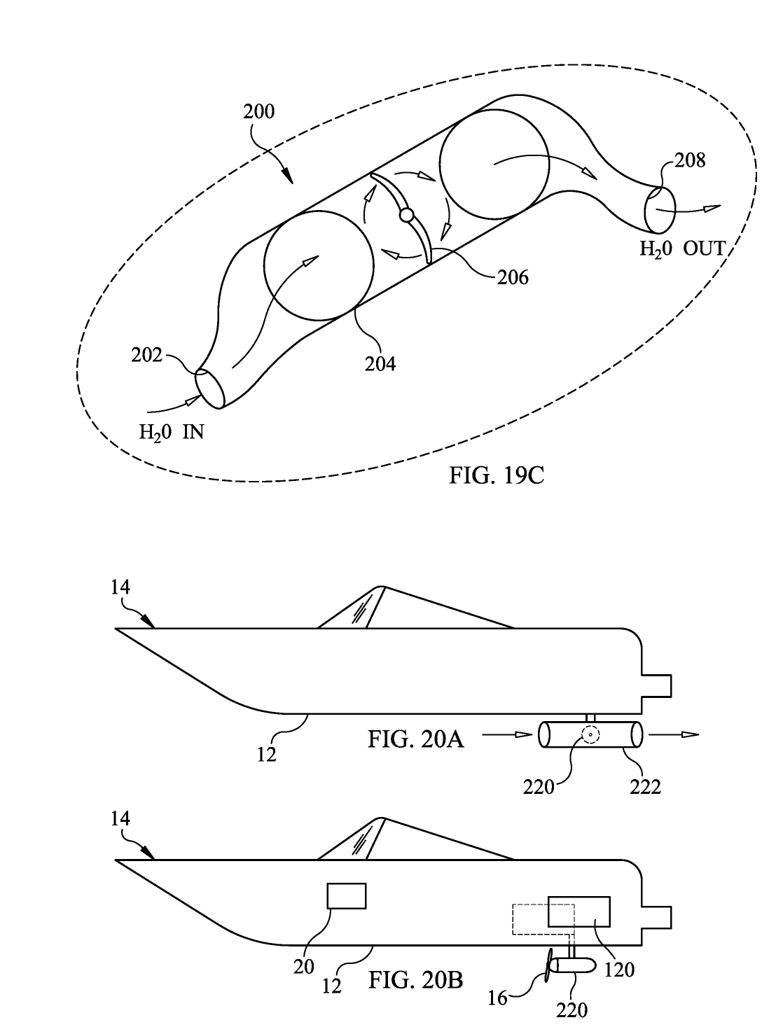

It now will be appreciated that the electric propulsion system 10 of the present invention further may comprise an internal turbine regenerative charging system 200, shown in FIGS. 19A, 19B, and 19C. An aperture 202 in the hull 12 of the watercraft 14 receives a tube 204 connected to a water turbine 206. An aperture 208 in the hull 12 leads back to the outside environment of the marine application in which the watercraft 14 is operating. The size of the turbine 206, as well as regeneration charging needs, will dictate the size of apertures 202 and 208.

As the watercraft 14 travels forward or backward, water passes by the hull 12, forcing some marine water through the aperture 202, much like a water turbine in a dam, and the water spins the turbine 206 within the watercraft 14, thereby creating mechanical energy. This power may be net equal while the watercraft 14 is under power. The apertures 202 and 208 may be covered, if desired or when the turbine 200 is not in use. However, when the watercraft 14 is slowing down or coming to a stop, the water passing by the hull 12 would spin the turbine 206, creating mechanical energy, which is fed into the battery pack 18 via the charger 20 or inverter 120. The water is then expelled through aperture 208 in the hull 12 back into the marine environment. In another embodiment, the water that has already passed through the turbine 206 can be fed through the exhaust, raw water output already in place on the boat, thus limiting the number of holes needed to be drilled into the hull 12. Any type of turbine 206 can be used for this application. This is an entirely closed system and does not use the water for anything other than spinning the turbine 206. However, one embodiment of the invention could use the water that has passed through the turbine 206 to go to the heat exchanger before being expelled. The water input aperture 202 and output aperture 208 may have wire mesh coverings or other material to keep solid objects from damaging the turbine 206. An internal turbine regenerative charging system 200 is not required for operation of the electric propulsion system 10 but one or more of these systems 200 may be installed on the watercraft 14, if desired.

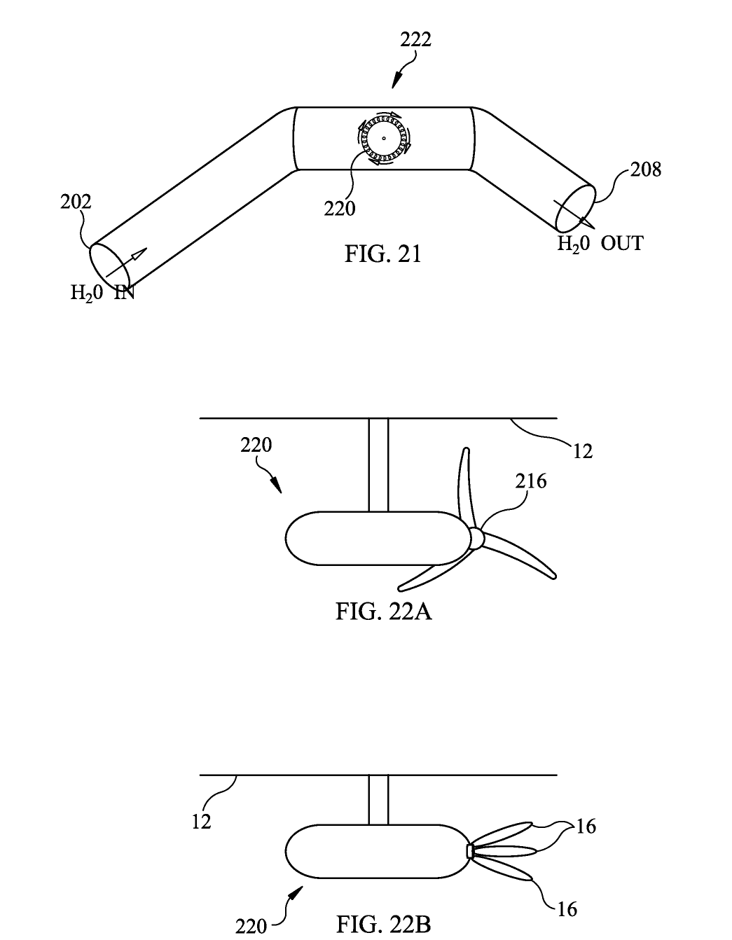

In alternative embodiments of the invention 10, shown in FIGS. 20A, 20B, 21, 22A and 22B, the moving recharger 200 is an external turbine 220 that is placed on the bottom of the hull 12 or that hangs from the transom of the watercraft 14. FIGS. 20A and 21 show an external pod 222, comprising a turbine 220 within the pod, which suspends externally from the hull 12 of the watercraft 14. The turbine 220 spins while the watercraft 14 is propelled through the water and generates energy when slowing down, similar to a regenerative braking apparatus. As it spins, the turbine 220 generates mechanical energy, which is fed to the inverter 120 or charger 20 and back into the battery pack 18.

In an alternative embodiment shown in FIGS. 20B, 22A and 22B, the moving recharger 200 is not encased within a pod but comprises an external turbine 220 with propeller blades 216 suspended from the hull 12 of the watercraft 14. The propeller blades 216 of external propeller 220 can retract or fold to be more aerodynamic and cause less friction while not in use. This minimizes friction while the watercraft is moving. When the watercraft is slowing or coming to a stop, the turbine 220 deploys to create mechanical power.

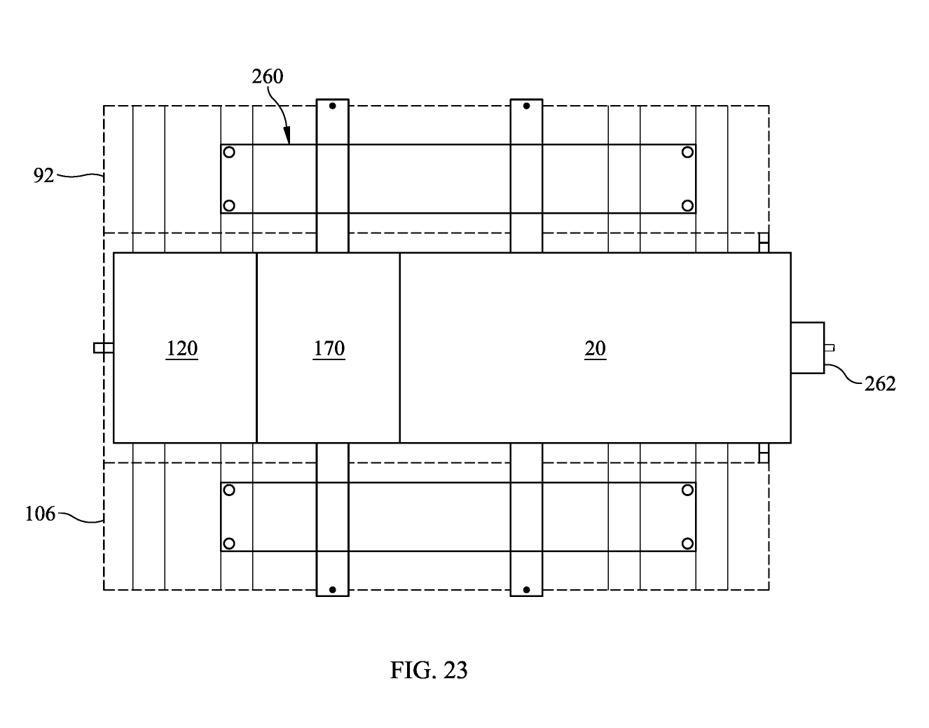

FIG. 23 shows one exemplary embodiment of an AC electric motor 20, inverter 120, and controller 170 setup with two heat exchangers 92 and 106 on a mount 260 and suitable for use in accordance with the electric propulsion system 10 of the present invention. However, a DC motor 20 can be used as well as an AC motor, in which case the inverter 120 can be omitted. Power comes from the battery pack 18 to the inverter 120 where it is changed from DC to AC. The inverter 120 is connected to the motor 20 by internal bus bars (not shown) and the controller 170 dictates the speed at which the motor spins and other functions are performed. In other embodiments, the controller 170 and inverter 120 do not have to be one unit and do not have to be connected directly into the motor either. One embodiment can have a gearbox 262 between the motor 20 and the shaft (not shown) to the drive unit of the watercraft. If this is not needed, it can be omitted. On the sides of the motor mount 260 are two large heat exchangers 92 and 106, which have a closed loop raw water system 60a that is pumped from outside the watercraft 14 through the cooling system 66 then back out of the watercraft. Any number of heat exchangers can be used and placed on or in the watercraft 14, wherever it is most convenient. Two internal closed loops would pump coolant through the heat exchangers 92 and 106 before going on to cool the battery cells 30, motor 22, controller 170, inverter 120 and other components. All of these components would be sealed in waterproof corrosion proof casings and have waterproof connections and hookups.

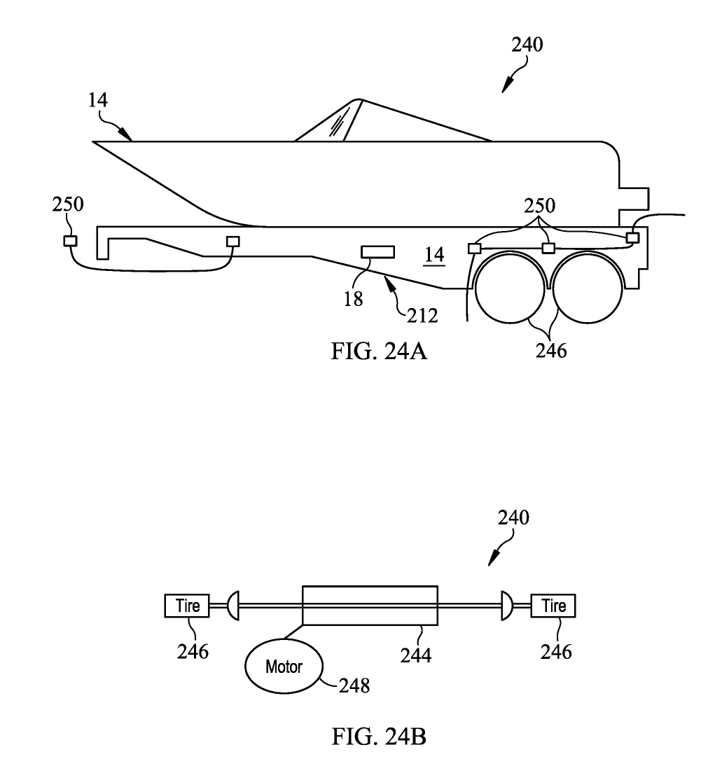

FIGS. 24A and 24B show a trailer regenerative braking and boat/EV car recharging system 240. A trailer 242 comprising one or more axles 244 and having wheels 246, like any conventional boat trailer, is used to transport the watercraft 14 over land. One or more of these axles 244 would further comprise one or more electric motors 248 of any kind that would use regenerative braking to slow the trailer 242, much like a normal trailers brake pads. The regenerative braking can be the main form of braking the trailer 242 or used to augment normal braking techniques, such as brake pads. Rather than using normal braking, such as brake pads, electric motors 248 on each axle, hub motors or other type of electric motor use regenerative braking to slow the trailer behind the car. The trailer 242 can be wired to the watercraft 14 that it is carrying, and the energy created from regenerative braking can be fed into the watercraft's battery pack 18. A plurality of chargers 250 are dispersed through the trailer regenerative braking and boat/EV car recharging system 240. The trailer 242 can be wired to the electric vehicle pulling it, and the regenerative braking energy can be fed into the electric vehicle's battery to provide a greater range when towing. In one embodiment, the trailer 242 could have a battery pack 18 (not shown) to provide extended range for the electric vehicle towing it.

The present invention further comprises a method of using an electric propulsion system in a marine environment. The foregoing paragraphs are incorporated into the description of the method of the present invention. In accordance with the method of the present invention, a plurality of battery cells 30 are provided in a shape configurable to the hull 12 of a watercraft 14. Battery cells 30 may be configured into arrays of battery blocks, which in turn may be configured into arrays of battery modules 34, which in turn may be configured into a battery pack 18. An electric propulsion system 10 comprising the battery pack comprised of a plurality of battery cells 30 may be positioned within or on the hull 12 of the watercraft 14 in a variety of configurations. This variable modularity enables the battery pack 18 to conform to small and/or oddly shaped areas in the hull 12 where the fuel tank previously had been, or to occupy extra space in the engine compartment or fill other storage locations throughout the watercraft 14. Power is provided from the battery pack 18 to an electric motor 22, which may be either AC or DC. The motor 22 spins a thrust mechanism 16 on the watercraft 14. In the case of an AC motor 22, an inverter 120 further is provided to convert the DC to AC to spin the motor. Chargers may be provided to convert AC to DC from the electric grid to the battery cells 30, while an inverter 120 tied in with the power-train converts the DC from the battery cells 30 to AC for the induction motor 22, which then spins the thrust mechanism 16. The battery cells 30 are cooled by water and/or other liquid coolant, such as anti-freeze or a combination thereof through cooling loops 60 which travel through the battery modules 34 and the battery pack 18. The coolant makes contact with each battery cell 30. Bi-direction flow of the coolant may be provided so that a constant continuous supply of cooled coolant is traveling through each module 34 of the battery pack and making contact with each battery cell 34 at any one time. The method further comprises the step of monitoring the voltage of each battery block in the module 34 and gathering data regarding the state of charge, battery cell protection, battery charger contact, cell balancing, current, fault detection, temperature, humidity, smoke, orientation, water content and information about the electric propulsion system 10. The method further provides the step of communicating this information to a VCU 132.

The method of the present invention may further provide the step of releasing exhaust from the system 10 or gas pressure build-up in a battery 18 or other source of pressure.

The method may further comprise the step of creating mechanical energy by passing water from the marine application through a water turbine situated on or in the hull 12 of the watercraft 14. The mechanical energy is transformed into electrical power and fed to the battery pack 18 of the system 10.

The method may further provide the step of supplying power from the braking system of a trailer 242 that is hauling a watercraft 14. Power from the braking system of the trailer 242 is fed to the battery pack 18 of the watercraft during transport of the watercraft. Additionally, power from the braking system from the trailer 242 may be fed to the electric battery of a vehicle towing the trailer.

The invention of this application has been described above both generically and with regard to specific embodiments. Although the invention has been set forth in what is believed to be preferred embodiments, a wide variety of alternatives known to those of skill in the art can be selected within the generic disclosure. Changes may be made in the combination and arrangement of the various parts, elements, steps and procedures described herein without departing from the spirit and scope of the invention as defined in the following claims.

We claim:

1. A modular battery pack for use in an electric propulsion system for a watercraft having a hull, the modular battery pack comprising:
a plurality of battery cells conformable into a shape configurable to the hull of the watercraft.

2. The modular battery pack of claim 1 wherein the plurality of battery cells forms a battery block comprising a nonconductive substrate for holding the battery cells and a collector plate for collecting electric charge from the battery cells.

3. The modular battery pack of claim 2 wherein the substrate of the battery block forms a plurality of battery cell receivers comprising teeth for gripping the battery cells within the battery cell receivers.

4. The modular battery pack of claim 2 further comprising multiple battery blocks and wherein the battery blocks form a battery module.

5. The battery module of claim 4 wherein the substrates of the battery blocks form the housing for the battery module.

6. The battery module of claim 4 wherein the battery cells are wired in parallel or in series.

7. The battery module of claim 4 wherein the battery blocks are wired in parallel or in series.

8. The modular battery pack of claim 4 further comprising a plurality of battery modules, wherein the battery modules are wired in series or in parallel.

9. The modular battery pack of claim 4 further comprising a cooling system.

10. The modular battery pack of claim 9 wherein the battery cells in the battery module are configured in offset rows of two and wherein the cooling system comprises a cooling loop that contacts each battery cell and that travels through the battery cells in a winding pattern.

11. The modular battery pack of claim 10 wherein the cooling loop has a diameter and the battery cells have a length and wherein the diameter of the cooling loop is substantially equal to the length of the battery cells.

12. The modular battery pack of claim 9 wherein the cooling system is wrapped in heat absorbing material.

13. The modular battery pack of claim 10 wherein the cooling loop further comprises a plurality of tubes contained within the cooling loop for transporting coolant.

14. The modular battery pack of claim 13 further comprising a plurality of cooling loops wherein the coolant in the cooling loops travels through the cooling loops in opposite directions.

15. The modular battery pack of claim of claim 9 wherein the cooling system further comprises heat exchangers and more than one cooling loop and wherein at least one of the more than one cooling loops employs as a coolant ambient water from a marine application in which the watercraft is used.

16. The modular battery pack of claim 8 further comprising a channel for holding in place the plurality of modules and for containing electrical wires, cables and cooling conduits.

17. The modular battery pack of claim 8 further comprising a battery management system for each battery module.

18. The modular battery pack of claim 16 wherein the channel further comprises emergency exhaust outputs.

19. An electric propulsion system for a watercraft having a hull, the electric propulsion system comprising:
a modular battery pack comprising a plurality of battery cells conformable into a shape configurable to the hull of the watercraft.

20. The electric propulsion system of claim 19 wherein the plurality of battery cells forms a battery block comprising a nonconductive substrate for holding the battery cells and a collector plate for collecting electric charge from the battery cells.

21. The electric propulsion system of claim 20 wherein the substrate of the battery block forms a plurality of battery cell receivers comprising teeth for gripping the battery cells within the battery cell receivers.

22. The electric propulsion system of claim 20 further comprising multiple battery blocks and wherein the battery blocks form a battery module.

23. The electric propulsion system of claim 22 wherein the substrates of the battery block form the housing for the battery module.

24. The electric propulsion system of claim 22 wherein the battery cells are wired in parallel or in series.

25. The electric propulsion system of claim 22 wherein the battery blocks are wired in parallel or in series.

26. The electric propulsion system of claim 20 further comprising a plurality of battery modules to form the battery pack, wherein the battery modules are wired in series or in parallel.

27. The electric propulsion system of claim 19 further comprising a plurality of battery packs, wherein the plurality of battery packs is wired in series or in parallel.

28. The electric propulsion system of claim 23 further comprising a cooling system.

29. The electric propulsion system of claim 28 wherein the battery cells in the battery module are configured in offset rows of two and wherein the cooling system further comprises a cooling loop that contacts each battery cell and that travels through the battery cells in a winding pattern.

30. The electric propulsion system of claim 29 wherein the cooling loop as a diameter and the better cells have length and wherein the diameter of the cooling loop is substantially equal to the length of the battery cells.

31. The electric propulsion system of claim 28 wherein the cooling loop is wrapped in heat absorbing material.

32. The electric propulsion system of claim 29 wherein the cooling loop further comprises a plurality of tubes contained with the cooling loop for transporting coolant.

33. The electric propulsion system of claim 29 further comprising a plurality of cooling loops wherein the coolant travels through the cooling loops in opposite directions.

34. The electric propulsion system of claim 28 wherein the cooling system further comprises heat exchangers and more than one cooling loop and wherein at least one of the more than one cooling loops employs as a coolant ambient water from a marine application in which the watercraft is used.

35. The electric propulsion system of claim 26 further comprising a channel for holding in place the plurality of modules and for containing electrical wires, cables and cooling conduits.

36. The electric propulsion system of claim 26 further comprising a battery management system for each battery module.

37. The electric propulsion system of claim 35 wherein the channel further comprises emergency exhaust outputs.

38. The electric propulsion system of claim 35 further comprising a master battery management system in communication with the battery management system for each battery module.

39. The electric propulsion system of claim 19 further comprising a thrust mechanism.

40. The electric propulsion system of claim 19 further comprising a turbine regenerative charging system.

41. The electric propulsion system of claim 19 further comprising a vehicle control unit.

42. The electric propulsion system of claim 19 further comprising:
a charger for converting AC power to DC power and sending the power to the battery pack; and
a charging port for receiving power to charge the battery pack.

43. The electric propulsion system of claim 28 further comprising an electric motor, a power train, a thrust mechanism, an inverter and a controller.

44. A trailer for hauling a watercraft having a modular battery pack, the trailer comprising:
at least one axle and a plurality of wheels connected to the axle;
a regenerative braking system comprising an electric motor in communication with the at least one axle; and
an electric charging system whereby energy from the regenerative braking system is transferred to the modular battery pack of the watercraft.

45. The trailer of claim 44 further wherein, when the trailer is hauled by an electric vehicle having a battery, energy from the electric charging system of the trailer is transferred to the battery of the electric vehicle.

46. The trailer of claim 44 further comprising a battery pack.

47. A cooling system for an electric propulsion system for a watercraft having use in marine applications, the cooling system comprising:
at least one cooling loop;
at least one heat exchanger;
wherein the at least one cooling loop employs ambient water from the marine application as a coolant for the electric propulsion unit.

48. A method of using an electric propulsion system for a watercraft in a marine application, the watercraft having a hull and the method comprising the steps of:
providing a plurality of battery cells in a shape configurable to the hull of the watercraft; and
providing power from the battery cells to an electric motor.

49. The method of claim 48 further comprising the step of spinning a thrust mechanism on the watercraft 14 to propel the watercraft forward.

50. The method of claim 48 further comprising the step of converting direct current from the battery cells to alternating current.

51. The method of claim 50 further comprising the steps of converting alternating current from the electric grid to direct current to the battery cells.

52. The method of claim 48 further comprising the step of cooling the battery cells.

53. The method of claim 52 further comprising the step of cooling each battery cell with a bi-directional flow of the coolant.

54. The method of claim 52 further comprising the step of cooling the battery cells with ambient water from the marine application.

55. The method of claim 48 further comprises the step of monitoring the voltage of the battery cells and gathering data regarding the components of the electric propulsion system.

56. The method of claim 55 further comprising the step of communicating the gathered data regarding the components of the electric propulsion system to a vehicle control unit.

57. The method of claim 48 wherein the electric propulsion system produces exhaust or gas pressure and where the method further comprises the step of releasing exhaust or gas pressure.

58. The method of claim 48 further comprising the steps of creating mechanical energy by passing water from the marine application through a water turbine situated on or in the hull of the watercraft and transforming mechanical energy into electrical power that is fed to the battery cells.
